(19) United States
(12) Patent Application Publication
(10) Pub. No.: US 2026/0124085 A1
(43) Pub. Date: May 7, 2026

(54) BED AUTOMATIC TRANSPORTATION SYSTEM

(71) Applicant: Paramount Bed Co., Ltd., Tokyo (JP)

(72) Inventors: Kenichi KATSUBE, Koto-ku Tokyo (JP); Yutaka NAGANO, Koto-ku Tokyo (JP)

(21) Appl. No.: 19/217,474

(22) Filed: May 23, 2025

(30) Foreign Application Priority Data
Nov. 6, 2024 (JP) 2024-194486

(51) Int. Cl. A61G 7/018; A61G 7/05

(52) U.S. Cl. CPC A61G 7/018; A61G 7/0528; A61G 2203/10

(57) ABSTRACT

A bed automatic transportation system includes: a bed including sections in which a back section, an upper leg section, and a lower leg section are disposed; a drive unit; a first controller configured to control automatic transportation; and a second controller. The second controller is configured to: execute a first operation of raising the back section in a case where a travelling direction of the bed is toward a lower leg section side, and execute a second operation of raising the upper leg section and the lower leg section in a case where the travelling direction of the bed is toward a back section side; and execute the second operation in a case where the travelling direction of the bed is toward the lower leg section side, and execute the first operation when the travelling direction of the bed is toward the back section side.

### CROSS-REFERENCE TO RELATED APPLICATIONS

This application is based upon and claims the benefit of priority from Japanese Patent Application No. 2024-194486, filed on Nov. 6, 2024; the entire contents of which are incorporated herein by reference.

### FIELD

Embodiments as examples relate to a bed automatic transportation system.

### BACKGROUND

Conventionally, automatic transportation systems for wheelchairs, automobiles, and the like have been disclosed. Those automatic transportation systems acquire route information when information on destinations is input, and automatically travel to the destinations.

If it is attempted to apply the automatic transportation system to a bed, since a person is lying on the bed, an impact is put on the person lying on the bed when the automatic transportation system moves off and when the automatic transportation system stops moving, and a position of the person lying on the bed may be shifted in some cases.

### BRIEF DESCRIPTION OF THE DRAWINGS

FIG. 1 is a block diagram illustrating a principal configuration of a bed automatic transportation system according to an embodiment.

FIG. 2 is a perspective view illustrating a bed.

FIG. 3 is a plan view illustrating a state where sections are detached.

FIG. 4 is a flowchart illustrating a series of operations of the bed automatic transportation system according to the embodiment.

FIG. 5 is an image view of sections in a flat state seen from a bed left side surface.

FIG. 6 is an image view seen from the bed left side surface in a state where the second controller has executed a first operation in a case where the travelling direction of the bed is toward a lower leg section side.

FIG. 7 is an image view seen from the bed right side surface in a state where the second controller has executed a second operation in a case where the travelling direction of the bed is toward a back section side.

FIG. 8 is an image view seen from the bed left side surface in a state where the second controller has executed the second operation in a case where the travelling direction of the bed is toward the lower leg section side.

FIG. 9 is an image view seen from the bed right side surface in a state where the second controller has executed the first operation in a case where the travelling direction of the bed is toward the back section side.

FIG. 10 is an image view seen from the bed left side surface in a state where the second controller has executed the first operation and the second operation in a case where the travelling direction of the bed is toward the lower leg section side.

FIG. 11 is an image view seen from the bed left side surface in a state where the second controller has executed a third operation in a case where the travelling direction of the bed is toward the lower leg section side.

FIG. 12 is an image view seen from the bed right side surface in a state where the second controller 60 has executed the third operation in a case where the travelling direction of the bed is toward the back section 12 side.

FIG. 13 is an image view seen from the bed left side surface in a state where the second controller has executed a fourth operation in a case where the travelling direction of the bed is toward the lower leg section side.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non-transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

In general, one aspect of the present application is a bed automatic transportation system including: a bed including sections in which a back section, an upper leg section, and a lower leg section are disposed; a drive unit configured to drive the bed; a first controller configured to control automatic transportation of the bed to a destination by the drive unit; and a second controller configured to raise and lower the back section, the upper leg section, and the lower leg section. The second controller is configured to: when the bed moves off toward the destination, execute a first operation of raising the back section in a case where a travelling direction of the bed is toward a lower leg section side, and execute a second operation of raising the upper leg section and the lower leg section in a case where the travelling direction of the bed is toward a back section side; and when the bed approaches the destination and stops moving, execute the second operation in a case where the travelling direction of the bed is toward the lower leg section side, and execute the first operation when the travelling direction of the bed is toward the back section side.

Hereinafter, embodiments of the present disclosure will be described with reference to the drawings.

In the present specification, in a case where a user is lying in a supine position on a bed or mattress, when the user is viewed from his/her body, a direction in which his/her head is located is referred to as a “head side”, a direction in which his/her feet are located is referred to as a “foot side”, a direction in which his/her right hand is located is referred to as a “right side”, a direction in which his/her left hand is located is referred to as a “left side”, a direction in which a floor surface of a room is located is referred to as a “lower side”, and a direction in which a ceiling is located is referred to as an “upper side”. The right side and the left side are also collectively referred to as a “lateral direction”, the head side and the foot side are also collectively referred to as a “longitudinal direction”, and the upper side and the lower side are also collectively referred to as a “vertical direction”.

A bed automatic transportation system according to the present embodiment will be described. The automatic transportation system according to the present embodiment is used for automatic transportation of a medical bed and a care bed, for example. The medical beds and the care beds are also used in care facilities, in addition to medical institutions such as hospitals.

In the bed automatic transportation system according to the present embodiment, in a case where a bed is automatically transported to the destination, in order to mitigate an impact on a person lying on the bed and to reduce a position shift when the bed moves off, when the bed stops moving, and when the bed collides with an obstacle, sections of the bed take a pre-crash posture in accordance with the situation. The pre-crash posture indicates a state where an impact on a person lying on a bed is mitigated when the bed moves off, when the bed stops moving, and when the bed collides with an obstacle. Hereinafter, the automatic transportation system according to the present embodiment will be described using the drawings.

### First Embodiment

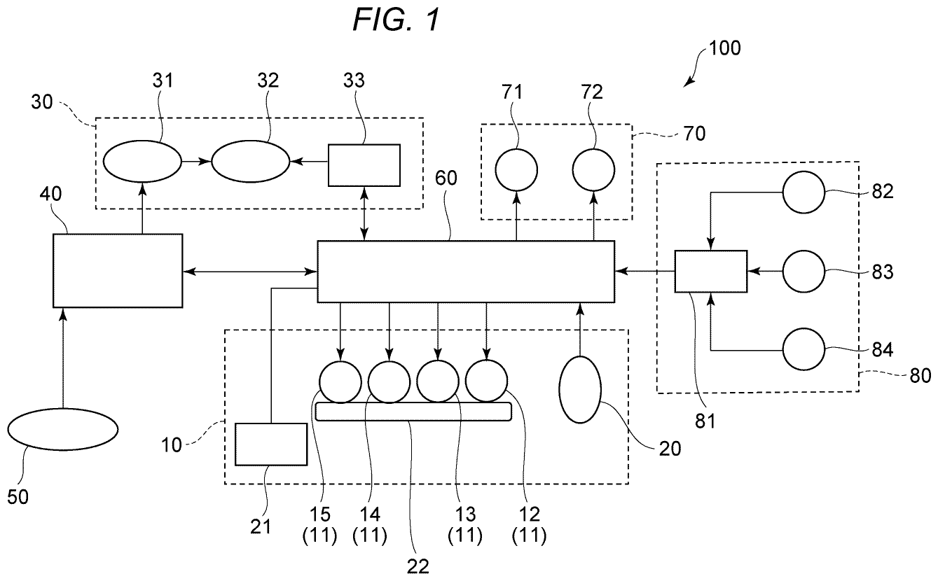

FIG. 1 is a block diagram illustrating a principal configuration of a bed automatic transportation system according to an embodiment.

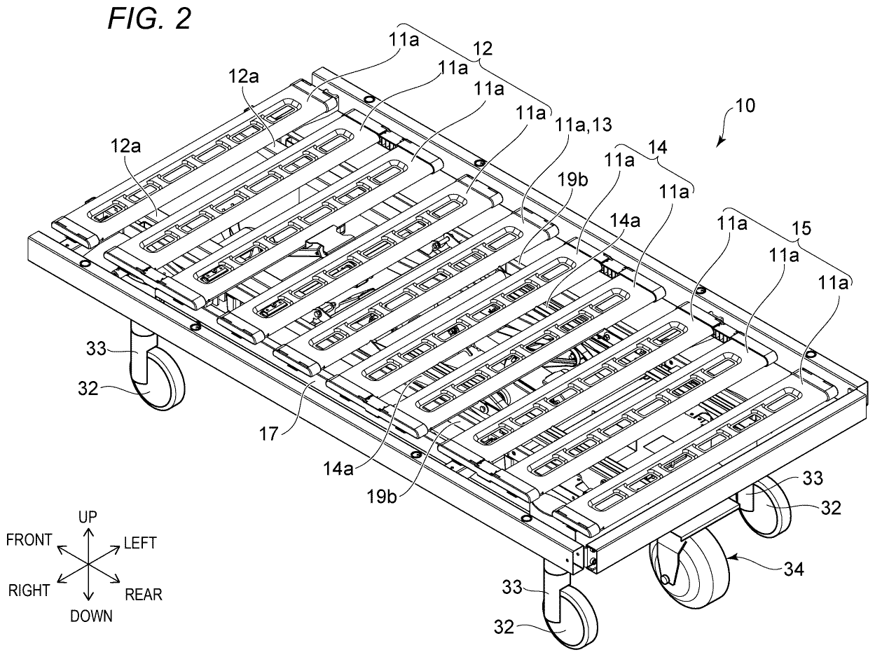

FIG. 2 is a perspective view illustrating a bed.

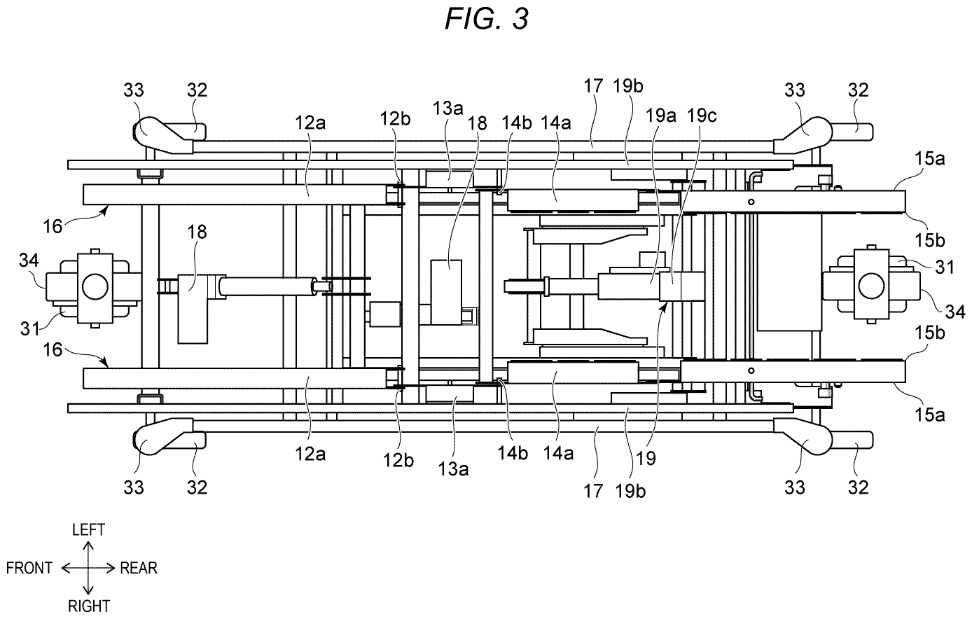

FIG. 3 is a plan view illustrating a state where sections are detached.

Firstly, a configuration in a bed automatic transportation system 100 according to the embodiment will be described.

The bed automatic transportation system 100 according to the embodiment is provided with a bed 10, a drive unit 30, a first controller 40, an operation unit 50, and a second controller 60.

The bed 10 includes sections 11 in which a back section 12, a seat section 13, an upper leg section 14, and a lower leg section 15 are disposed, section frames 16, a base frame 17, a lifting mechanism 19 that lifts up and down the sections 11, casters 32, and an auxiliary driving wheel 34.

The base frame 17 is formed in a frame shape, for example. The two section frames 16 are provided being separated in the lateral direction and along the longitudinal direction of the bed 10. The base frame 17 is provided below the section frames 16.

The back section 12 includes a plurality of section members 11a. Each of the plurality of section members 11a is fixed to back frames 12a that support the section members 11a from the lower side. Each back frame 12a is fixed to each section frame 16. The back section 12 is disposed on a head side of a person lying on the bed 10. The back section 12 also supports the head part or the back of a person lying on the bed 10. In each back frame 12a, with the operation of an actuator 18, a foot side in the back section 12 serves as a pivot point 12b to vertically move a head end side. This allows the back section 12 to be raised and lowered relative to the section frames 16.

The seat section 13 is disposed closer to the foot side than the back section 12 is. The seat section 13 includes a section member 11a. The section member 11a is fixed to seat part frames 13a that support the section member 11a from the lower side. Each seat part frame 13a is fixed to each section frame 16. The seat section 13 also supports the seat part or the buttocks of a person lying on the bed 10.

The upper leg section 14 is disposed closer to the foot side than the seat section 13 is. The upper leg section 14 includes a plurality of section members 11a. Each of the plurality of section members 11a is fixed to upper leg part frames 14a that support the section members 11a from the lower side. Each upper leg part frame 14a is fixed to each section frame 16. The upper leg section 14 supports thighs of a person lying on the bed 10. In each upper leg part frame 14a, with the operation of the actuator 18, a head side in the upper leg section 14 serves as a pivot point 14b to vertically move the foot side. This allows the upper leg section 14 to be raised and lowered relative to the section frames 16.

The lower leg section 15 is disposed closer to the foot side than the upper leg section 14 is. The lower leg section 15 includes a plurality of section members 11a. Each of the plurality of section members 11a is fixed to lower leg part frames 15a that support the section members 11a from the lower side. Each lower leg part frame 15a is fixed to each section frame 16. The lower leg section 15 supports leg regions of a person lying on the bed 10. In each lower leg part frame 15a, with the operation of the actuator 18, a foot side in the lower leg section 15 serves as a pivot point 15b to vertically move a head side. This allows the lower leg section 15 to be raised and lowered relative to the section frames 16.

The lifting mechanism 19 includes an electric cylinder 19a and lifting frames 19b. The lifting frames 19b are supported by the base frame 17, and connected to the section frames 16 respectively. The lifting mechanism 19 drives a lifting motor 19c, and lifts up and down the section frames 16 via the lifting frames 19b. In other words, the lifting mechanism 19 lifts up and down the sections 11. The lifting mechanism 19 can adjust a height dimension from a floor surface and the base frame 17 to the sections 11. The lifting mechanism 19 can select the height dimension from three stages of high, middle, and low, for example. Moreover, the lifting mechanism 19 can tilt the section frames 16 by raising the head side of the section frames 16 and lowering the foot side of the section frames 16.

The bed 10 may further include a global positioning system (GPS) receiver 20, a communicator 21, and a load sensor 22. The communicator 21 is used in making a nurse call, and is connected to a nurse station or the like via a wireless network. The load sensor 22 is disposed between the sections 11 and the section frames 16, and measures the body weight of a person lying on the bed 10.

The casters 32 are provided in four corners of the base frame 17. The casters 32 are free casters that can turn so as to follow a travelling direction of the bed 10. The casters 32 may be free casters on the front wheel side, and fixed casters on the rear wheel side.

The auxiliary driving wheel 34 rotates upon receiving power from a motor 31. The auxiliary driving wheel 34 causes the bed 10 to electrically travel.

The drive unit 30 includes the motor 31, the auxiliary driving wheel 34, the casters 32, and caster lock controllers 33 that respectively lock the casters 32. The drive unit 30 drives the bed 10 by the motor 31 and the auxiliary driving wheel 34. The motor 31, the casters 32, the caster lock controllers 33, and the auxiliary driving wheel 34 are provided to the base frame 17. The caster lock controller 33 is a mechanism that mechanically locks the caster 32 by a human operation and electronic control.

The first controller 40 is a computer control device that controls automatic transportation of the bed 10 to a destination by the drive unit 30. The first controller 40 is connected to the operation unit 50 via a wired or wireless network. The operation unit 50 issues a command to the first controller 40. Examples of the operation unit 50 can include a remote controller. Upon receiving the command from the operation unit 50, the first controller 40 issues a command to the drive unit 30 to cause the bed 10 to move off, be automatically transported to a destination, and stop moving. The first controller 40 can accelerate and decelerate the bed 10.

The second controller 60 is a computer control device that operates the actuator 18 to, for example, raise and lower the back section 12, the upper leg section 14, and the lower leg section 15. When the bed 10 moves off and when the bed stops moving, the second controller 60 raises and lowers the back section 12, the upper leg section 14, and the lower leg section 15, and executes some operations.

The second controller 60 is connected to each of the sections 11, the GPS receiver 20, the communicator 21, the first controller 40, the caster lock controllers 33, and a notification unit 70 and an obstacle determination unit 80, which are described later, via a wired or wireless network.

The bed automatic transportation system 100 according to the embodiment is further provided with the notification unit 70 and the obstacle determination unit 80. The notification unit 70 announces that the second controller 60 raises and lowers the back section 12, the upper leg section 14, and the lower leg section 15 to a person lying on the bed 10. The notification unit 70 can include an LED light 71, a speaker 72, and the like. The obstacle determination unit 80 determines the presence or absence of an obstacle from when the bed 10 moves off toward a destination to when the bed 10 stops moving. The obstacle determination unit 80 includes a communication device 81, a camera 82 that recognizes an image, a millimeter-wave radar 83 that measures a distance between the bed 10 and an obstacle, and a time of flight (TOF) sensor 84. The camera 82, the millimeter-wave radar 83, and the TOF sensor 84 detect an obstacle. If the obstacle determination unit 80 has determined that an obstacle is “present”, the obstacle determination unit 80 transmits the information from the communication device 81 to the second controller 60.

Next, a series of operations of the bed automatic transportation system 100 according to the embodiment will be described.

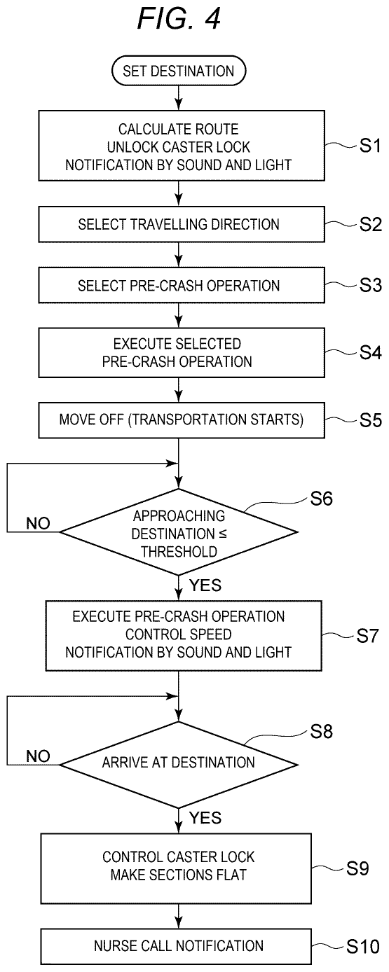

FIG. 4 is a flowchart illustrating a series of operations of the bed automatic transportation system according to the embodiment.

Firstly, at S1, in the bed automatic transportation system 100 according to the embodiment, the first controller 40 receives a command from the operation unit 50 to set a destination. The destination is, for example, an operating room, an inspecting room, a sickroom, or a corridor. The first controller 40 then performs a route calculation to the destination. A CPU or the like included in the first controller 40 performs a route calculation. The GPS receiver 20 or the like grasps position information on the bed 10. The second controller 60 causes the caster lock controllers 33 to unlock the casters 32. The bed 10 then becomes in a movable state, and when the bed 10 moves off, the second controller 60 notifies a person lying on the bed 10, a person in the surrounding, and other persons that the bed 10 moves off and a pre-crash operation (which will be described later) is performed, by a sound notification with the speaker 72 and by the LED light 71. The pre-crash operation is an operation for taking a pre-crash posture.

Thereafter, at S2, the first controller 40 selects a travelling direction of the bed 10. Specifically, when the bed 10 moves off toward a destination, the first controller 40 selects whether the travelling direction of the bed 10 is toward the lower leg section 15 side or the back section 12 side. Whether the lower leg section 15 side or the back section 12 side changes depending on a situation at that time. For example, when the bed 10 is in a sickroom and an entrance of the sickroom is closer to the lower leg section 15, the travelling direction is toward the lower leg section 15 side. When the bed 10 is in a corridor and the shortest route is closer to the back section 12, the travelling direction is toward the back section 12 side. The first controller 40 transmits information on the travelling direction to the second controller 60.

Thereafter, at S3, the second controller 60 having received the information on the travelling direction raises the back section 12, the upper leg section 14, and the lower leg section 15 in order to mitigate an impact when the bed 10 moves off, and selects at least one pre-crash operation among some pre-crash operations.

Thereafter, at S4, the second controller 60 executes the selected pre-crash operation. The sections 11 of the bed 10 are normally flat. When the bed 10 moves off and when the bed 10 stops moving, a load is applied in a reverse direction of the travelling direction, an impact is applied to a person lying on the bed 10 to cause a position shift. When the bed 10 collides with an obstacle, a load is applied in a reverse direction of the travelling direction, an impact is applied to a person lying on the bed 10 to cause a position shift. The bed automatic transportation system 100 according to the embodiment performs some pre-crash operations by raising the back section 12, the upper leg section 14, and the lower leg section 15 to mitigate an impact on a person lying on the bed 10 when the bed 10 moves off, when the bed 10 stops moving, and when the bed 10 collides with an obstacle, so as to reduce a position shift. The specific manners of the pre-crash operations will be described later.

Thereafter, at S5, after the second controller 60 executes a pre-crash operation, the information is transmitted to the first controller 40. The first controller 40 having received the information transmits a moving-off command to the drive unit 30 in order to start the transportation of the bed 10. The drive unit 30 having received the moving-off command causes the bed 10 to move off toward a destination.

During the automatic transportation, environment information on a peripheral region of a predetermined bed 10 is successively acquired by the camera 82, the millimeter-wave radar 83, and the TOF sensor 84, which are included in the obstacle determination unit 80, at predetermined sampling intervals (for example, 0.1 to 1 second).

The obstacle determination unit 80 determines the presence or absence of an obstacle based on the environment information during the automatic transportation. The obstacle determination unit 80 calculates a distance between one or a plurality of obstacles included in the environment information and the bed 10, a relative travelling direction, and a travelling speed, and calculates a possibility that the focused obstacle collides with the bed 10 as a collision risk score. If an obstacle having a collision risk score greater than a predetermined threshold is present, the obstacle determination unit 80 outputs an announcement that “There is a possibility of collision. The impact will be mitigated.” from the notification unit 70, and controls the drive unit 30 and the first controller 40 to change the transportation speed of the bed 10 to an “avoidance speed” that is a low speed and avoid the obstacle, or suddenly stop the bed 10.

Thereafter, at S6, the first controller 40 determines whether the bed 10 has approached the destination. For example, the first controller 40 sets a threshold to 3 m, and repeats the abovementioned determination if the distance to the destination exceeds 3 m, and proceeds to the next if the distance to the destination is equal to or less than 3 m.

Thereafter, at S7, if the first controller 40 has determined that the bed 10 has approached the destination, the first controller 40 transmits the information to the second controller 60. The second controller 60 having received the information raises the back section 12, the upper leg section 14, and the lower leg section 15 in order to mitigate an impact when the bed 10 stops, and executes at least one pre-crash operation among some pre-crash operations. The pre-crash operation when the bed 10 stops moving is different from the pre-crash operation when the bed 10 moves off. The first controller 40 performs speed control for mitigating an impact when the bed 10 stops. Specifically, the first controller 40 decreases the speed of the bed 10. The second controller 60 makes a notification of executing a pre-crash operation to a person lying on the bed 10, a person in the surrounding, and other persons, by the sound notification with the speaker 72 and by the LED light 71.

Thereafter, at S8, the first controller 40 determines whether the bed 10 has arrived at the destination. The first controller 40 repeats the abovementioned determination if the bed 10 does not arrive at the destination, and proceeds to the next if the bed 10 has arrived at the destination.

Thereafter, at S9, if the first controller 40 has determined that the bed 10 has arrived at the destination, the first controller 40 transmits the information to the second controller 60. The second controller 60 having received the information causes the caster lock controllers 33 to lock the casters 32. The second controller 60 lowers the back section 12, the upper leg section 14, and the lower leg section 15, which have been raised, to make the sections flat.

Thereafter, at S10, the second controller 60 causes the communicator 21 to make a nurse call. The second controller 60 may cause the notification unit 70 to announce that the bed 10 has arrived at the destination to a person lying on the bed 10 and a medical staff in the surrounding.

Next, some pre-crash operations will be described.

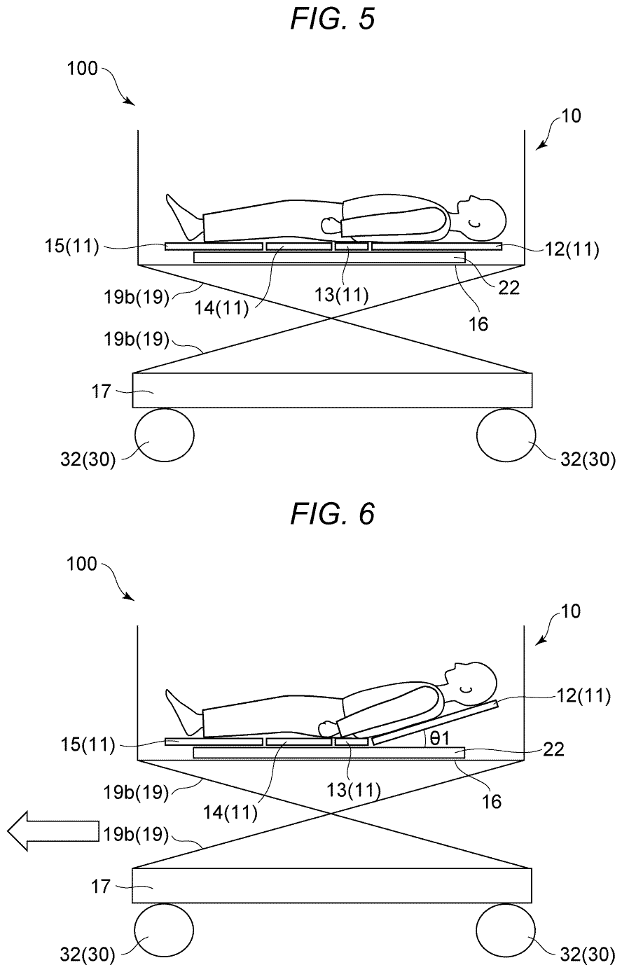

FIG. 5 is an image view of sections in a flat state seen from a bed left side surface.

FIG. 6 is an image view seen from the bed left side surface in a state where the second controller has executed a first operation in a case where the travelling direction of the bed is toward a lower leg section side.

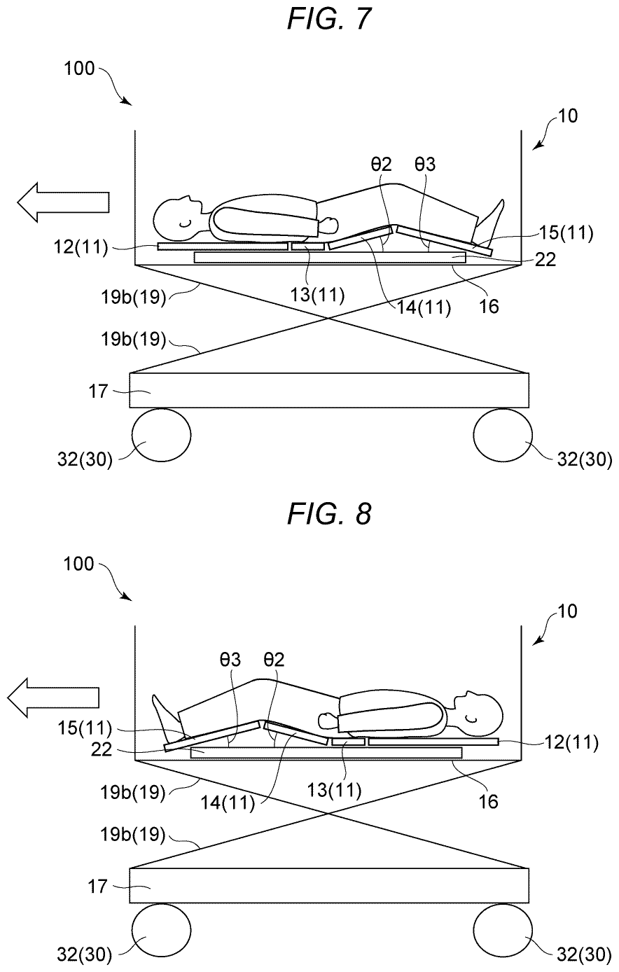

FIG. 7 is an image view seen from the bed right side surface in a state where the second controller has executed a second operation in a case where the travelling direction of the bed is toward a back section side.

In a case where no pre-crash operation is performed and no pre-crash posture is taken in the bed 10, the sections 11 are in a flat state as illustrated in FIG. 5. In other words, the back section 12, the seat section 13, the upper leg section 14, and the lower leg section 15 are in a collapsed state.

The bed automatic transportation system 100 according to the embodiment causes the second controller 60 to execute a pre-crash operation when the bed 10 moves off toward a destination and when the bed 10 stops moving. A manner in which the pre-crash operation is performed varies depending on a case where the travelling direction of the bed 10 in moving off is toward the lower leg section 15 side, a case where the travelling direction of the bed 10 in moving off is toward the back section 12 side, a case where the travelling direction of the bed 10 in stopping moving is toward the lower leg section 15 side, and a case where the travelling direction of the bed 10 in stopping moving is toward the back section 12 side.

Firstly, a case where the bed 10 moves off toward a destination will be described. In a case where the travelling direction of the bed 10 is toward the lower leg section 15 side, the second controller 60 executes a first operation as illustrated in FIG. 6. The first operation makes the back section 12 be in a raised state. The seat section 13, the upper leg section 14, and the lower leg section 15, other than the back section 12, are in a collapsed state. An angle θ1 at which the back section 12 is raised is, for example, equal to or greater than 15 degrees and equal to or less than 30 degrees relative to the section frames 16 and the base frame 17.

To the contrary, in a case where the travelling direction of the bed 10 is toward the back section 12 side, the second controller 60 executes a second operation as illustrated in FIG. 7. The second operation makes the upper leg section 14 and the lower leg section 15 be in a raised state. The back section 12 and the seat section 13, other than the upper leg section 14 and the lower leg section 15, are in a collapsed state. Each of angles θ2 and θ3 at which the upper leg section 14 and the lower leg section 15 are raised is, for example, equal to or greater than 15 degrees and equal to or less than 30 degrees relative to the section frames 16 and the base frame 17.

In this manner, in a case where the travelling direction of the bed 10 is toward the lower leg section 15 side and a case where the travelling direction of the bed 10 is toward the back section 12 side, the bed automatic transportation system 100 according to the embodiment causes the second controller 60 to execute the first operation and the second operation, thereby making it possible to mitigate an impact on a person lying on the bed 10 when the bed 10 moves off, and to reduce a position shift.

Next, a case where the bed 10 approaches a destination and stops moving will be described.

FIG. 8 is an image view seen from the bed left side surface in a state where the second controller has executed the second operation in a case where the travelling direction of the bed is toward the lower leg section side.

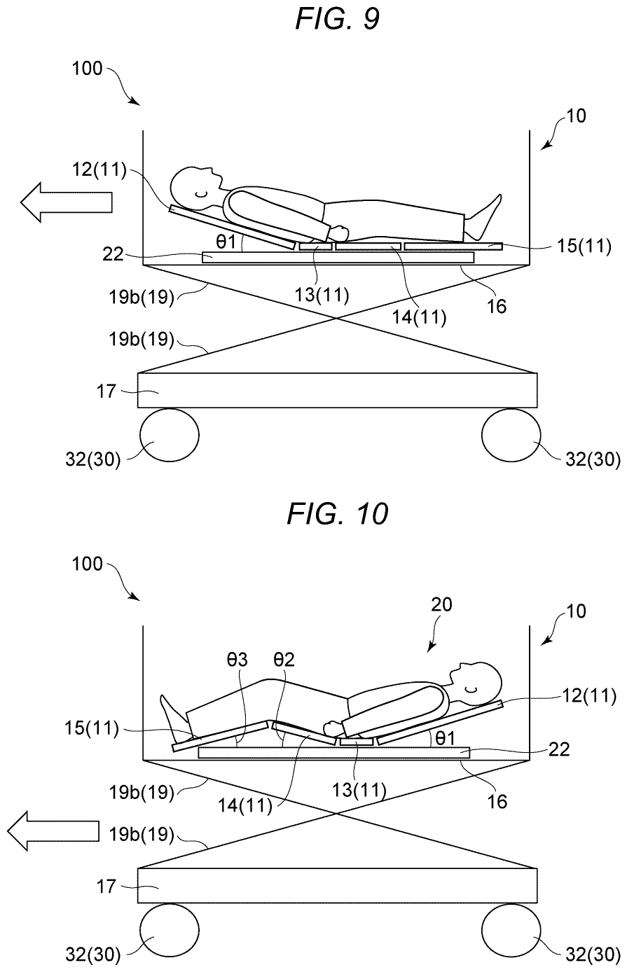

FIG. 9 is an image view seen from the bed right side surface in a state where the second controller has executed the first operation in a case where the travelling direction of the bed is toward the back section side.

In a case where the travelling direction of the bed 10 is toward the lower leg section 15 side, the second controller 60 executes the second operation as illustrated in FIG. 8. The second operation is as described above.

To the contrary, in a case where the travelling direction of the bed 10 is toward the back section 12 side, the second controller 60 executes the first operation as illustrated in FIG. 9. The first operation is as described above.

In this manner, in the case where the travelling direction of the bed 10 is toward the lower leg section 15 side and the case where the travelling direction of the bed 10 is toward the back section 12 side, the bed automatic transportation system 100 according to the embodiment causes the second controller 60 to execute the first operation and the second operation, thereby making it possible to mitigate an impact on a person lying on the bed 10 when the bed 10 stops moving, and to reduce a position shift.

### Second Embodiment

FIG. 10 is an image view seen from the bed left side surface in a state where the second controller has executed the first operation and the second operation in a case where the travelling direction of the bed is toward the lower leg section side.

In the first embodiment, as a pre-crash operation, the second controller has executed the first operation or the second operation. In the second embodiment, as illustrated in FIG. 10, when the bed 10 moves off toward a destination, in a case where the travelling direction of the bed 10 is toward the lower leg section 15 side, the second controller 60 further executes the second operation, in addition to the first operation. In a case where the travelling direction of the bed 10 is toward the back section 12 side, the second controller 60 may further execute the first operation, in addition to the second operation. In other words, when the bed 10 moves off, in a case where the travelling direction of the bed 10 is toward the lower leg section 15 side and a case where the travelling direction of the bed 10 is toward the back section 12 side, the second controller 60 may execute both of the first operation and the second operation. In this way, as compared with a case where only the first operation or the second operation is performed, it is possible to further mitigate an impact to a person lying on the bed 10 when the bed 10 moves off, and to further reduce a position shift.

When the bed 10 arrives at the destination and stops moving, in a case where the travelling direction of the bed 10 is toward the lower leg section 15 side, the second controller 60 may further execute the first operation, in addition to the second operation. In a case where the travelling direction of the bed 10 is toward the back section 12 side, the second controller 60 may further execute the second operation, in addition to the first operation. In other words, when the bed 10 stops moving, in a case where the travelling direction of the bed 10 is toward the lower leg section 15 side and a case where the travelling direction of the bed 10 is toward the back section 12 side, the second controller 60 may execute both of the first operation and the second operation. In this way, as compared with a case where only the first operation or the second operation is performed, it is possible to further mitigate an impact to a person lying on the bed 10 when the bed 10 stops moving, and to further reduce a position shift.

When the second controller 60 executes the first operation and the second operation, the notification unit 70 may make an announcement to a person lying on the bed 10.

Next, an aspect of the sections in the first embodiment and the second embodiment during the automatic transportation from when the bed 10 moves off toward a destination to when the bed 10 stops moving will be described.

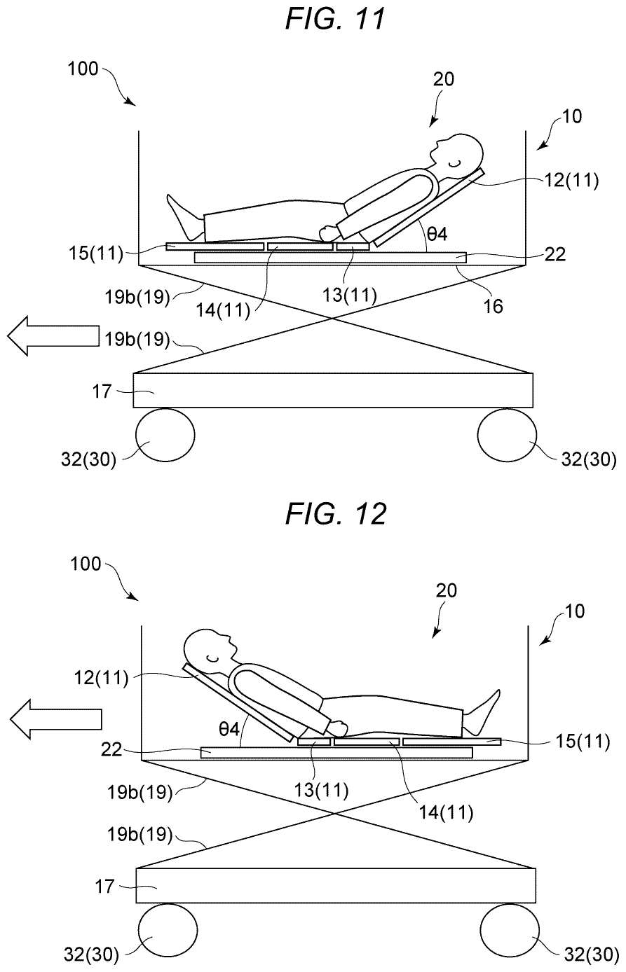

From when the bed 10 moves off toward a destination to when the bed 10 stops moving, the sections 11 may be flat, but in order to secure a field of vision of a person lying on the bed 10, the back section 12 is preferably raised. FIG. 11 illustrates an example as to how to achieve what is described above.

FIG. 11 is an image view seen from the bed left side surface in a state where the second controller has executed a third operation in a case where the travelling direction of the bed is toward the lower leg section side.

The second controller 60 executes the third operation from when the bed 10 moves off toward a destination to when the bed 10 stops moving, as illustrated in FIG. 11. The back section 12 is raised in the third operation higher than in the first operation. The second controller 60 executes the third operation in both of the case where the travelling direction of the bed 10 is toward the lower leg section 15 side and the case where the travelling direction of the bed 10 is toward the back section 12 side. An angle θ4 at which the back section 12 is raised is, for example, equal to or greater than 15 degrees and equal to or less than 45 degrees relative to the section frames 16 and the base frame 17. In this way, it is possible to secure a field of vision of a person lying on the bed 10 during the automatic transportation, and to provide a sense of security. In a case where an obstacle is present during the automatic transportation, by securing the field of vision, the lying person can grasp the obstacle, and thus can brace for an impact when the bed 10 collides with the obstacle. When the bed moves off and when the bed stops moving, the second controller may execute the third operation.

From when the bed 10 moves off toward a destination to when the bed 10 stops moving, the second controller may prohibit an operation by a person lying on the bed 10. In order to prohibit the abovementioned operation, for example, an input to the operation unit 50 may be invalid. In this way, an unnecessary operation input to the operation unit 50 by a bed user is not allowed, so that it is possible to avoid such a situation that an automatic transportation control operation by the bed automatic transportation system 100 is unintentionally hindered, and to cause the bed automatic transportation system 100 to exhibit the most effects on the safe transportation.

From when the bed 10 moves off toward a destination to when the bed 10 stops moving, the lifting mechanism 19 may set the sections 11 at a lowered position. This improves the traveling stability during the automatic transportation.

When the bed 10 moves off, when the bed 10 stops moving, and when the bed 10 collides with an obstacle, the lifting mechanism 19 provides an inclination to the section frames 16, thereby allowing the section frames 16 to take a pre-crash posture. When the bed 10 moves off, when the bed 10 stops moving, and when the bed 10 collides with an obstacle, the lifting mechanism 19 can select the low stage among the three stages of high, middle, and low. This can mitigate an impact to a person lying on the bed 10.

Next, a pre-crash posture in a case where the obstacle determination unit 80 has determined that an obstacle is present in the travelling direction of the bed 10 from when the bed 10 moves off toward a destination to when the bed 10 stops moving will be described.

FIG. 12 is an image view seen from the bed right side surface in a state where the second controller 60 has executed the third operation in a case where the travelling direction of the bed is toward the back section 12 side.

An obstacle is present on the route in the automatic transportation in some cases. The obstacle determination unit 80 determines the presence or absence of an obstacle, and if the obstacle determination unit 80 has determined as “present”, the second controller 60 executes a pre-crash operation in preparation for an impact. In a case where the travelling direction of the bed 10 is toward the back section 12 side, the second controller 60 executes the third operation of raising the back section 12 higher than that in the first operation, as illustrated in FIG. 12. The angle θ4 at which the back section 12 is raised in the third operation is as described above. In this way, even when the bed 10 suddenly stops moving so as not to collide with an obstacle or collides with an obstacle, it is possible to mitigate an impact to a person lying on the bed 10, and to reduce a position shift.

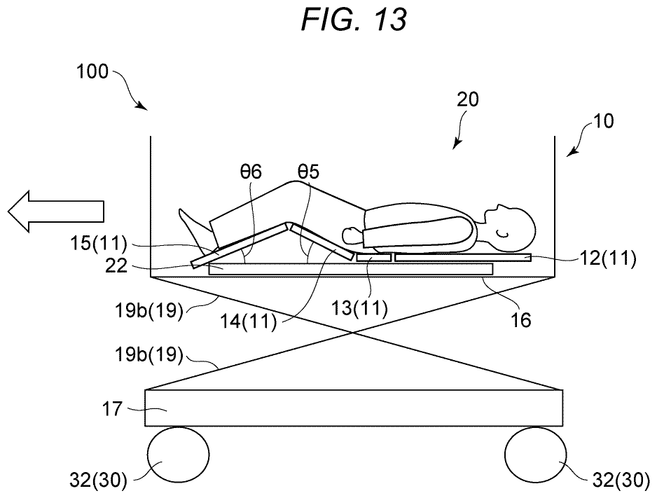

FIG. 13 is an image view seen from the bed left side surface in a state where the second controller has executed a fourth operation in a case where the travelling direction of the bed is toward the lower leg section side.

In a case where the travelling direction of the bed 10 is toward the lower leg section 15 side, the second controller 60 executes the fourth operation. The upper leg section 14 and the lower leg section 15 are raised in the fourth operation higher than in the second operation. Angles θ5 and θ6 at which the upper leg section 14 and the lower leg section 15 are respectively raised are, for example, greater than 15 degrees and equal to or less than 45 degrees relative to the section frames 16 and the base frame 17. In this way, even when the bed 10 collides with an obstacle, it is possible to mitigate an impact to a person lying on the bed 10, and to reduce a position shift.

When the obstacle determination unit 80 has determined that an obstacle is “present” to attain a pre-crash posture in preparation for an impact, the second controller 60 quickly executes the abovementioned third operation and fourth operation. At this time, for example, maximum rated control input is provided to the actuator 18 that adjusts an angle of each of the sections 11 (12, 14, 15). This can raise each of the sections 11 (12, 14, 15) at higher speed compared to when the angle is adjusted when the bed 10 moves off and when the bed 10 stops moving, and shorten the time before a pre-crash operation is performed. In the bed 10, the actuator 18 that is used for angle adjustment of each of the sections 11 (12, 14, 15) when the bed 10 moves off and when the bed 10 stops moving, and a linear actuator or the like capable of operating at higher speed than the actuator 18 may be disposed in parallel. This can further shorten the time before the selected pre-crash operation is performed.

Impacts when the bed 10 moves off, when the bed 10 stops moving, and when the bed 10 collides with an obstacle vary depending on the body weight of a person lying on the bed 10. The second controller 60 may adjust, depending on the body weight obtained by the load sensor 22, angles at which the back section 12, the upper leg section 14, and the lower leg section 15 are raised in the first operation, the second operation, the third operation, and the fourth operation. Specifically, the back section 12, the upper leg section 14, and the lower leg section 15 are raised at angles for a person having a body weight of 90 kg larger than those for a person having a body weight of 70 kg within the abovementioned ranges of the angles θ1, θ2, θ3, and θ4. In this way, it is possible to precisely mitigate an impact to a person lying on a bed when the bed moves off and when the bed stops moving, and to further reduce a position shift.

The bed 10 may include a plurality of air cells between the bed 10 and the sections 11. The plurality of air cells are connected to a pump that causes the air to flow into the air cells. At this time, the pump is used to significantly increase the air-supplying speed, thereby causing the air cells to suddenly swell and contract. This can mitigate the impacts from the right side and the left side.

The case where the angles of the respective unit sections are automatically controlled in the automatic transportation driving to automatically take positions at which an impact at the collision is mitigated has been described in the abovementioned embodiments; however, the positions at which the impact is mitigated are not limited to the angle control of the respective unit sections. The bed automatic transportation system 100 is provided with a mechanism that can adjust the height of the sections 11 of the bed 10 at the back section 12 side and the height of the sections 11 of the bed 10 at the lower leg section 15 side. The bed automatic transportation system 100 can adjust an inclined angle of the entire sections by independently controlling the height at the back section 12 side and the height at the lower leg section 15 side. For example, in a case where the travelling direction of the bed 10 is toward the back section 12 side, as a pre-crash posture during the automatic transportation, the second controller 60 executes an operation of setting the height of an end of the sections 11 at the lower leg section 15 side to be higher than that at an end of the sections 11 at the back section 12 side. In a case where the travelling direction of the bed 10 is toward the lower leg section 15 side, as a pre-crash posture during the automatic transportation, the second controller 60 executes an operation of setting the height of the end of the sections 11 at the back section 12 side to be higher than that of the end of the sections 11 at the lower leg section 15 side. In this manner, in the bed automatic transportation system 100, an operation of taking a pre-crash posture may be executed by setting the inclined angle of the entire sections 11. In the abovementioned operation, the lifting mechanism 19 provides an inclination to the section frames 16 to perform the abovementioned operation.

The aforementioned embodiment and modified example are examples embodying the present disclosure, and the present disclosure is not limited to these embodiment and modified example. For example, in each of the aforementioned embodiments and modified examples, the present disclosure also includes additions, deletions, or modifications of some elements or steps. In addition, the aforementioned embodiments and modified examples may be implemented in combination.

The present disclosure includes the following aspects.

### Appendix 1

A bed automatic transportation system comprising:
a bed including sections in which a back section, an upper leg section, and a lower leg section are disposed;
a drive unit configured to drive the bed;
a first controller configured to control automatic transportation of the bed to a destination by the drive unit; and
a second controller configured to raise and lower the back section, the upper leg section, and the lower leg section, wherein
the second controller is configured to
when the bed moves off toward the destination, execute a first operation of raising the back section in a case where a travelling direction of the bed is toward a lower leg section side, and execute a second operation of raising the upper leg section and the lower leg section in a case where the travelling direction of the bed is toward a back section side, and
when the bed approaches the destination and stops moving, execute the second operation in a case where the travelling direction of the bed is toward the lower leg section side, and execute the first operation when the travelling direction of the bed is toward the back section side.

### Appendix 2

The bed automatic transportation system according to appendix 1, wherein the second controller is configured to
when the bed moves off toward the destination, further execute the second operation in the case where the travelling direction of the bed is toward the lower leg section side, and further execute the first operation in the case where the travelling direction of the bed is toward the back section side, and
when the bed arrives at the destination and stops moving, further execute the first operation in the case where the travelling direction of the bed is toward the lower leg section side, and further execute the second operation in the case where the travelling direction of the bed is toward the back section side.

### Appendix 3

The bed automatic transportation system according to appendix 1, wherein the second controller is configured to execute a third operation of raising the back section higher than that in the first operation from when the bed moves off toward the destination to when the bed stops moving.

### Appendix 4

The bed automatic transportation system according to appendix 1, wherein the second controller prohibits an operation by a person lying on the bed from when the bed moves off toward the destination to when the bed stops moving.

### Appendix 5

The bed automatic transportation system according to appendix 1, wherein
the bed further includes a lifting mechanism configured to lift up and down the sections, and
the lifting mechanism is configured to set the sections at a lowered position from when the bed moves off toward the destination to when the bed stops moving.

Appendix 6 The bed automatic transportation system according to appendix 1, further comprising:
a notification unit configured to make an announcement to a person lying on the bed when the second controller executes the first operation and the second operation.

### Appendix 7

The bed automatic transportation system according to appendix 1, wherein the drive unit includes a caster, and a caster lock controller configured to suppress rotation of the caster.

### Appendix 8

The bed automatic transportation system according to appendix 1, further comprising:
an obstacle determination unit, wherein
from when the bed moves off toward the destination to when the bed stops moving, if the obstacle determination unit determines that an obstacle is present in a travelling direction of the bed, the second controller
executes the third operation of raising the back section higher than that in the first operation in the case where the travelling direction of the bed is toward the back section side, and
executes a fourth operation of raising the upper leg section and the lower leg section higher than those in the second operation in the case where the travelling direction of the bed is toward the lower leg section side.

### Appendix 9

The bed automatic transportation system according to appendix 8, wherein
the bed further includes a load sensor configured to measure a body weight of a person lying on the bed, and
the second controller is configured to adjust, in accordance with the body weight obtained by the load sensor, angles at which the back section, the upper leg section, and the lower leg section are raised in the first operation, the second operation, the third operation, and the fourth operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A bed automatic transportation system comprising:
a bed including sections in which a back section, an upper leg section, and a lower leg section are disposed;
a drive unit configured to drive the bed;
a first controller configured to control automatic transportation of the bed to a destination by the drive unit; and
a second controller configured to raise and lower the back section, the upper leg section, and the lower leg section, wherein
the second controller is configured to
when the bed moves off toward the destination, execute a first operation of raising the back section in a case where a travelling direction of the bed is toward a lower leg section side, and execute a second operation of raising the upper leg section and the lower leg section in a case where the travelling direction of the bed is toward a back section side, and
when the bed approaches the destination and stops moving, execute the second operation in a case where the travelling direction of the bed is toward the lower leg section side, and execute the first operation when the travelling direction of the bed is toward the back section side.

2. The bed automatic transportation system according to claim 1, wherein the second controller is configured to
when the bed moves off toward the destination, further execute the second operation in the case where the travelling direction of the bed is toward the lower leg section side, and further execute the first operation in the case where the travelling direction of the bed is toward the back section side, and
when the bed arrives at the destination and stops moving, further execute the first operation in the case where the travelling direction of the bed is toward the lower leg section side, and further execute the second operation in the case where the travelling direction of the bed is toward the back section side.

3. The bed automatic transportation system according to claim 1, wherein the second controller is configured to execute a third operation of raising the back section higher than that in the first operation from when the bed moves off toward the destination to when the bed stops moving.

4. The bed automatic transportation system according to claim 1, wherein the second controller prohibits an operation by a person lying on the bed from when the bed moves off toward the destination to when the bed stops moving.

5. The bed automatic transportation system according to claim 1, wherein
the bed further includes a lifting mechanism configured to lift up and down the sections, and
the lifting mechanism is configured to set the sections at a lowered position from when the bed moves off toward the destination to when the bed stops moving.

6. The bed automatic transportation system according to claim 1, further comprising:
a notification unit configured to make an announcement to a person lying on the bed when the second controller executes the first operation and the second operation.

7. The bed automatic transportation system according to claim 1, wherein the drive unit includes a caster, and a caster lock controller configured to suppress rotation of the caster.

8. The bed automatic transportation system according to claim 1, further comprising:
an obstacle determination unit, wherein
from when the bed moves off toward the destination to when the bed stops moving, if the obstacle determination unit determines that an obstacle is present in a travelling direction of the bed, the second controller
executes the third operation of raising the back section higher than that in the first operation in the case where the travelling direction of the bed is toward the back section side, and
executes a fourth operation of raising the upper leg section and the lower leg section higher than those in the second operation in the case where the travelling direction of the bed is toward the lower leg section side.

9. The bed automatic transportation system according to claim 8, wherein
the bed further includes a load sensor configured to measure a body weight of a person lying on the bed, and
the second controller is configured to adjust, in accordance with the body weight obtained by the load sensor, angles at which the back section, the upper leg section, and the lower leg section are raised in the first operation, the second operation, the third operation, and the fourth operation.
